(19) United States
(12) Patent Application Publication
(10) Pub. No.: US 2016/0104154 A1
(43) Pub. Date: Apr. 14, 2016

(54) SECURING HOST CARD EMULATION CREDENTIALS

(71) Applicant: Sequent Software, Inc., Mountain View, CA (US)

(72) Inventors: Peter Milov, San Jose, CA (US); David Brudnicki, Duvall, WA (US); Mark Villiott, Woodinville, WA (US)

(21) Appl. No.: 14/882,044

(22) Filed: Oct. 13, 2015

Related U.S. Application Data
(60) Provisional application No. 62/063,291, filed on Oct. 13, 2014.

(51) Int. Cl. G06Q 20/38; G06Q 20/32; G06Q 20/40; H04L 29/06; G06Q 20/36

(52) U.S. Cl. CPC G06Q 20/38215; H04L 63/0861; H04L 63/083; H04L 63/0807; H04L 63/0492; H04L 63/0853; G06Q 20/3674; G06Q 20/401; G06Q 20/3278; G06Q 2220/00

(57) ABSTRACT

Systems and methods for providing token generation and password verification are disclosed. The system may be configured to receive a password input by a user, wherein the password is not stored on the system prior to receiving the password, and to generate an encryption key based on the password. The system may further be configured to decrypt a token using the encryption key and, in response to verifying that the token was properly decrypted, decrypting a credential using the encryption key. The system may additionally be configured to initiate a near-field communication transaction with a reader using the decrypted credential.

### CROSS-REFERENCE TO RELATED APPLICATIONS

This application claims priority to U.S. Provisional Application Ser. No. 62/063,291 filed on Oct. 13, 2014, the entire contents of which are hereby expressly incorporated herein by reference.

### TECHNICAL FIELD

The present invention relates generally to securing host card emulation (HCE) credentials, and more particularly to verifying an entered user password.

### BACKGROUND

Wireless transactions using RFID-based proximity cards are fairly common place. For instance, many workers use RFID keycards to gain access to their workplace and drivers use RFID passes to pay tolls at highway speeds. RFID, which stands for radio-frequency identification, uses electromagnetic waves to exchange data between a terminal and some object for the purpose of identification. More recently, companies have been trying to use RFIDs supported by cellular telephones to implement an electronic payment product (i.e., credit and/or debit card). However, basic RFID technology raises a number of security concerns that have prompted modifications of the basic technology. Still, widespread adoption of RFID as a mechanism for electronic payments has been slow.

Near Field Communication (NFC) is another technology that uses electromagnetic waves to exchange data. NFC waves are only transmitted over a short-range (on the order of a few inches) and at high-frequencies. NFC devices are already being used to make payments at point of sale devices. NFC is an open standard (see, e.g., ISO/IEC 18092) specifying modulation schemes, coding, transfer speeds, and RF interface. There has been wider adoption of NFC as a communication platform because it provides better security for financial transactions and access control. Other short distance communication protocols are known and may gain acceptance for use in supporting financial transactions and access control.

Many applications have been developed for use in association with portable communications devices. Some of these applications would benefit from having access to electronic funds to facilitate the consumer's consummation of electronic transactions via those applications, such as the purchase of goods over the Internet. Still other applications, such as electronic wallets, would have no purpose if they could not access the secure data subsystem of the portable communication device.

Card issuers are interested in facilitating the option to pay for application usage and ecommerce using their credit/debit card products. Notwithstanding their self-interest in enabling third party applications to access their financial products, the card issuers may have serious security concerns about broad distribution of security protocols. Similarly, the third party developers may not be interested in developing financial product subroutines. Accordingly, there is a need in the industry for an electronic wallet that is accessible by third party programs to facilitate the payment of charges associated with the use of those programs. The application accessible electronic wallet may also be used via direct access by the consumer to the mobile application.

Accordingly, the present invention seeks to provide one or more solutions to the foregoing problems and related problems as would be understood by those of ordinary skill in the art having the present specification before them. These and other objects and advantages of the present disclosure will be apparent to those of ordinary skill in the art having the present drawings, specifications, and claims before them. It is intended that all such additional systems, methods, features, and advantages be included within this description, be within the scope of the disclosure, and be protected by the accompanying claims.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

Methods, systems, apparatuses, and computer readable media are disclosed for providing token generation and password verification. The example embodiments may be configured to receive a password input by a user, wherein the password is not stored on a device prior to receiving the password, and to generate an encryption key based on the password. The example embodiments may further be configured to decrypt a token using the encryption key and, in response to ve1ifying that the token was properly decrypted, decrypting a credential using the encryption key. The example embodiments may additionally be configured to initiate a near-field communication transaction with a reader using the decrypted credential.

### BRIEF DESCRIPTION OF THE DRAWINGS

For a better understanding of the present disclosure, non-limiting and non-exhaustive embodiments are described in reference to the following drawings. In the drawings, like reference numerals refer to like parts through all the various figures unless otherwise specified.

FIG. 1a illustrates the end user's portable communication device conducting a secure payment transaction at a point of sale.

FIG. 1b illustrates the operable interconnections between the end user's smartphone and various subsystems, including the system management back end.

FIG. 2 is a block diagram illustrating some of the logical blocks within a portable communication device that may be relevant to the present system.

FIG. 3 is a block diagram illustrating the logical blocks within the system management back end.

FIG. 4 is a block diagram illustrating further detail of the “OpenWallet” block of FIG. 2 that may be relevant to the present system.

FIGS. 4A, 4B, 4C and 4D are illustrations of various screens from an exemplary wallet user interface that may be deployed on a smart phone.

FIG. 5 is a block diagram illustrating the operable interconnections between the end user's smartphone, a Secure Element Management Server, and a Credential Issuer Adapter server.

FIG. 6 is a block diagram of one potential implementation of a system underlying the grant of permission for one of the third party apps to view, select and/or change secure data stored in the payment subsystem.

FIG. 7 illustrates an example functional block diagram implementing a process for generating a token in accordance with example embodiments.

FIG. 8 illustrates an example functional block diagram implementing a process for verifying a user password in accordance with example embodiments.

FIG. 9 illustrates an example functional block diagram implementing a process for initiating a near field communication transaction in accordance with example embodiments.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

### Portable Communication Device

The present disclosure provides a system and method that can be utilized with a variety of different portable communication devices, including but not limited to POA's, cellular phones, smart phones, laptops, tablet computers, and other mobile devices that include cellular voice and data service as well as preferable access to consumer downloadable applications. One such portable communication device could be an iPhone, Motorola RAZR, DROID, or Samsung device; however, the present invention is preferably platform and device independent. For example, the po1table communication device technology platform may be Microsoft Windows Mobile, Microsoft Windows Phone 10, Palm OS, Apple OS, Android OS, Symbian, Java or any other technology platform. For purposes of this disclosure, the present invention has been generally described in accordance with features and interfaces that are optimized for a smart phone utilizing a generalized platform, although one skilled in the art would understand that all such features and interfaces may also be used and adapted for any other platform and/or device.

The portable communication device includes one or more short proximity electromagnetic communication devices, such as an NFC, RFID, or Bluetooth transceiver. It is presently preferred to use an NFC baseband that is Compliant with NFC IP 1 standards (www.nfcforum.org), which provides standard functions like peer-to-peer data exchange, reader-writer mode (i.e., harvesting of information from RFID tags), and contactless card emulation (per the NFC IP 1 and ISO 14443 standards) when paired with a secure element on the portable communication device and presented in front of a “contactless payment reader” (see below at point of sale). As would be understood in the art by those having the present specification, figures, and claims before them, the NFC IP 1 standards are simply the presently preferred example, which could be exported—in whole or in part—for use in association with any other proximity communication standard. It is further preferred that the portable communication device include an NFC/RFID antenna (conformed to NFC IP 1 and ISO 14443 standards) to enable near field communications. However, as would be understood in the art NFC/RFID communications may be accomplished albeit over even shorter ranges and potential read problems.

The portable communication device also includes a mobile network interface to establish and manage wireless communications with a mobile network operator. The mobile network interface uses one or more communication protocols and technologies including, but not limited to, global system for mobile communication (GSM), 3G, 4G, code division multiple access (COMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols to communicate with the mobile network of a mobile network operator. Accordingly, the mobile network interface may include a transceiver, transceiving device, or network interface card (NIC). It is contemplated that the mobile network interface and short proximity electromagnetic communication device could share a transceiver or transceiving device, as would be understood in the art by those having the present specification, figures, and claims before them.

The portable communication device further includes a user interface that provides some means for the consumer to receive information as well as to input information or otherwise respond to the received information. As is presently understood (without intending to limit the present disclosure thereto) this user interface may include a microphone, an audio speaker, a haptic interface, a graphical display, and a keypad, keyboard, pointing device and/or touch screen. As would be understood in the art by those having the present specification, figures, and claims before them, the portable communication device may further include a location transceiver that can determine its physical coordinates relative to the surface of the Earth, typically as a function of the device's latitude, longitude and altitude. This location transceiver preferably uses GPS technology, so it may be referred to herein as a GPS transceiver; however, it should be understood that the location transceiver can additionally (or alternatively) employ other gee-positioning mechanisms, including, but not limited to, triangulation, assisted GPS (AGPS), E-OTD, CI, SAI, ETA, BSS or the like, to determine the physical location of the portable communication device relative to the surface of the Earth.

The portable communication device will also include a microprocessor and mass memory. The mass memory may include ROM, RAM as well as one or more removable memory cards, and may be non-transitory. The mass memory provides storage for computer readable instructions and other data, including a basic input/output system (“BIOS”) and an operating system for controlling the operation of the portable communication device. The portable communication device will also include a device identification memory to identify the device, which may comprise dedicated memory such as a SIM card. As is generally understood, SIM cards contain the unique serial number of the device (ESN), an internationally unique number of the mobile user (IMSI), security authentication and ciphering information, temporary information related to the local network, a list of the services the user has access to and two passwords (PIN for usual use and PUK for unlocking). As would be understood in the art by those having the present specification, figures, and claims before them, other information may be maintained in the device identification memory depending upon the type of device, its primary network type, home mobile network operator, etc.

In the example embodiments each portable communication device may have two subsystems: (1) a “wireless subsystem” that enables communication and other data applications as has become commonplace with users of cellular telephones today, and (2) the “secure transactional subsystem” which may also be known as the “payment subsystem”. It is contemplated that this secure transactional subsystem optimally may include a Secure Element, similar (if not identical) to that described as part of current Global Platform standards (www.globalplatform.org). The secure element has been implemented as a specialized, separate physical memory used for industry common practice of storing payment card track data used with industry common point of sale; additionally, other secure credentials that can be stored in the secure element include employment badge credentials (enterprise access controls), hotel and other card-based access systems and transit credentials.

### Mobile Network Operator

Each of the portable communications devices is connected to at least one mobile network operator. The mobile network operator generally provides physical infrastructure that supports the wireless communication services, data applications and the secure transactional subsystem via a plurality of cell towers that communicate with a plurality of portable communication devices within each cell tower's associated cell. In turn, the cell towers may be in operable communication with the logical network of the mobile network operator, POTS, and the Internet to convey the communications and data within the mobile network operator's own logical network as well as to external networks including those of other mobile network operators. The mobile network operators generally provide support for one or more communication protocols and technologies including, but not limited to, global system for mobile communication (GSM), 3G, 4G, code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols to communicate with the portable communication devices.

### Retail Subsystem

Standard at merchants today is an Internet Protocol connected payment system that allows for transaction processing of debit, credit, prepay and gift products of banks and merchant service providers. By swiping a magnetic stripe enabled card at the magnetic reader of a Point of Sale Terminal, the card data is transferred to the point of sale equipment and used to confirm funds by the issuing bank. This point of sale equipment has begun to include contactless card readers as accessories that allow for the payment card data to be presented over an RF interface, in lieu of the magnetic reader. The data is transferred to the reader through the RF interface by the ISO 14443 standard and proprietary payment applications like PayPass and Paywave, which transmit the contactless card data from a card and in the future a mobile device that includes a Payment Subsystem.

A retailer's point of sale device 75 may be connected to a network via a wireless or wired connection. This point of sale network may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, the point of sale network may utilize any communication method that allows information to travel between the point of sale devices and financial services providers for the purpose of validating, authorizing and ultimately capturing financial transactions at the point of sale for payment via the same financial service providers.

### Secure Transactional Subsystem

The system may include a secure transactional subsystem. The secure transactional subsystem optionally may include a secure element and associated device software for communication to management and provisioning systems as well as the customer facing interface for use and management of secure data stored in the secure element. Preferably the secure transactional subsystem will conform, where appropriate, to an international standard, such as current Global Platform standards.

### System Management Back End

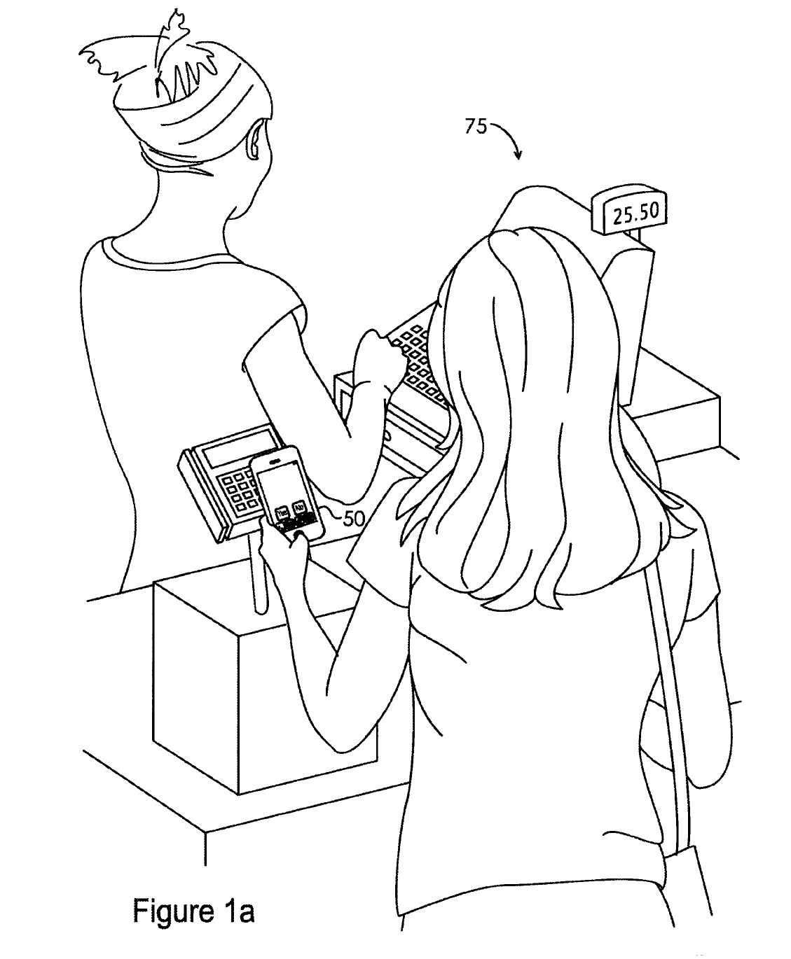

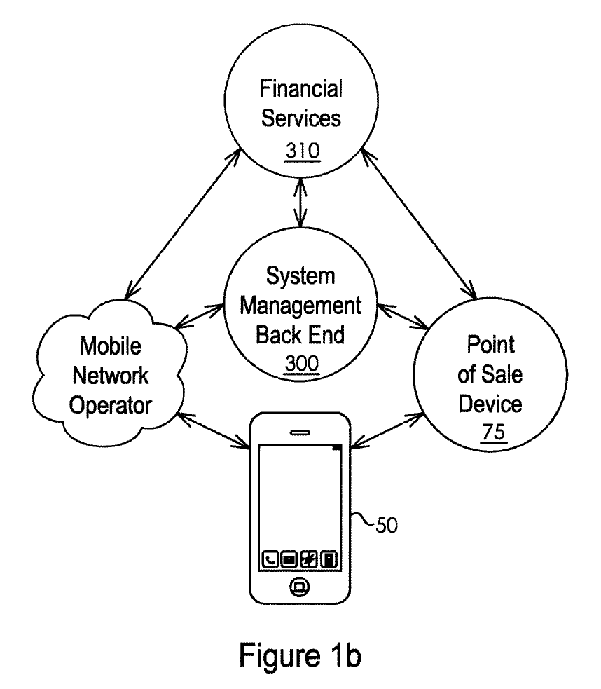

The system includes a system management back end. As shown in FIG. 1b, the system management back end 300 is connected to the retail subsystem, the secure transactional subsystem and to a plurality of portable communication devices via the infrastructure of at least one mobile network operator. The system management back end has a server operably communicating with one or more client devices. The server is also in operable communication with the retailer subsystem, secure transactional subsystem, and one or more portable communication devices. The server is also in operable communication with the retailer subsystem, secure transactional subsystem, and one or more portable communication devices. The communications include data and voice channels. Any type of voice channel may be used in association with the present invention, including but not limited to VoIP.

The server may comprise one or more general-purpose computers that implement the procedures and functions needed to run the system back office in serial or in parallel on the same computer or across a local or wide area network distributed on a plurality of computers and may even be located “in the cloud” (preferably subject to the provision of sufficient security). The computer(s) comprising the server may be controlled by Linux, Windows®, Windows CE, Unix, or a Java® based operating system, to name a few. The system management back end server is operably associated with mass memory that stores program code and data. Data may include one or more databases, text, spreadsheet, folder, file, or the like, that may be configured to maintain and store a knowledge base, user identifiers (ESN, IMSI, PIN, telephone number, email/IM address, billing information, or the like).

The system management back end server may support a case management system to provide call traffic connectivity and distribution across the client computers in the customer care center. In a preferred approach using VoIP voice channel connectivity, the case management system is a contact/case management system distributed by Oracle Corp. of Redwood Shores, Calif. Other contact/case management systems may be used, such as those available by Contractual, Inc. of Redwood City, Calif. The Oracle case management system is a standard CRM system for a VoIP-based customer care call center that also provides flexibility to handle care issues with simultaneous payments and cellular-related care concerns. As would be understood by one of ordinary skill in the art having the present specification, drawings and claims before them other case management systems may be utilized within the present invention such as Salesforce (Salesforce.com, Inc. of San Francisco, Calif.) and Novo (Novo Solutions, Inc. of Virginia Beach, Va.).

Each client computer associated with the system management back end server preferably has a network interface device, graphical user interface, and voice communication capabilities that match the voice channel(s) supported by the client care center server, such as VoIP. Each client computer can request status of both the cellular and secure transactional subsystems of a po1table communication device. This status may include the contents of the soft memory and core performance of portable communication device, the NFC components: baseband, NFC antenna, secure element status and identification.

### Federated Payment Subsystem

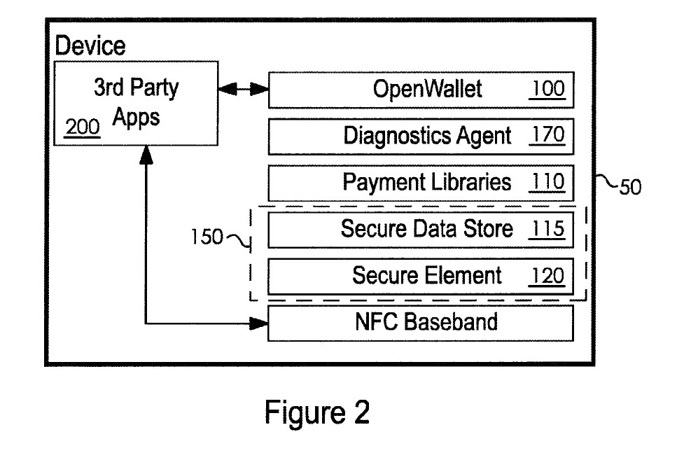

As shown in FIG. 2, each portable communication device 50 may contain one or more third party applications 200 (e.g., selected by the consumer), an “open architecture” electronic wallet 100 (referred to below as an “OpenWallet”), payment libraries 110, secure element 120, NFC Baseband, a payment subsystem 150 (i.e., secure data store 115 and secure element 120), and diagnostic agent 170. OpenWallet 100 can be thought of as a computer application that allows the consumer to see all credentials (e.g., card, coupon, access control and ticket data) stored in the device 50 (preferably in payment subsystem 150). OpenWallet 100 would also preferably track the issuers of all the credentials stored in the portable communication device's payment subsystem 150 and determine on an application-by-application basis whether that third party application should have permissions to view, select and/or change the credentials stored in the payment subsystem. In this manner, OpenWallet 100 also prevents unauthorized applications from accessing data stored in the payment subsystem 150, which they do not currently have permission to access.

The payment libraries 110 are preferably used by Open Wallet 100 to manage (and perform housekeeping tasks on) the secure element 120, interface with the system management back end, and perform over-the-air (OTA) provisioning via data communication transceiver (including its SMS channel), on the device 50. It is contemplated that the OTA data communications will be encrypted in some manner and an encryption key will be deployed in card services module 420. The payment subsystem 150 may be used to store credentials such as payment card, coupon, access control and ticket data (e.g., transportation, concert). Some of these payment types may be added to the payment subsystem by different applications 200 for use by those applications. In this manner, other third party applications (not shown) may be precluded from accessing the payment subsystem 150.

The secure data store 115 provides secured storage on the portable communication device 50. Various levels of security may be provided depending upon the nature of the data intended for storage in secure data store 115. For instance, secure data store 115 may simply be password-protected at the operating system level of device 50. As is known in these operating systems, the password may be a simple alphanumeric or hexadecimal code that is stored somewhere on the device 50. Alternatively, the data in secure data store 115 is preferably encrypted. In some examples, the secure data store 115 may be set up as a virtual secure element in the manner disclosed in the co-pending U.S. patent application (owned by the assignee of the present application) Ser. No. 13/279,147, entitled “System and Method for Providing A Virtual Secure Element on a Portable Communication Device,” filed Oct. 21, 2011, and hereby incorporated by reference in its entirety. As discussed later in the present application, for additional security the password may not be stored anywhere on the device 50.

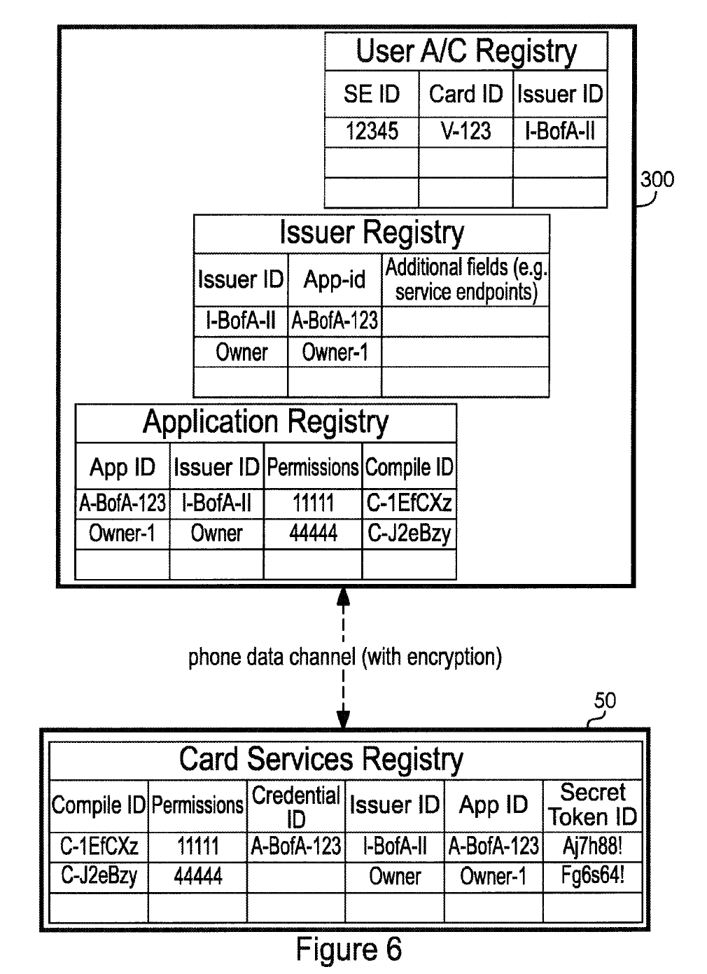

OpenWallet 100 preferably removes the complexity involved in the storage, maintenance and use of credentials such as card, coupon, ticket, access control data from one or multiple sources or issuers in association with the payment subsystem 150. OpenWallet 100 also preferably enforces access control to the data stored in the payment subsystem 150 and the functions allowed by each application. In one approach, OpenWallet 100 verifies the author/issuer of each third party application stored on the portable communication device 50. This verification may be accomplished by accessing a local authorization database of permitted (i.e., trusted) applications (see FIG. 6). Under this approach, only applications that are signed with a known Issuer ID and the correctly associated Compile ID are allowed by card services module 420 to access and/or manipulate data stored in the payment subsystem 150 and/or metadata repository 125 (which stores, among other things, card image data and any embossed card data).

In other words, when an application 200 or wallet user interface 410 needs to interact with the payment subsystem 150 it does so by passing a digital identifier (such as its Issuer ID or App ID), a digital token (i.e., Compile ID or Secret Token ID), the desired action, and any associated arguments needed for the action to the card services module 420. Card services module 420 verifies the digital identifier-digital token pair matches trusted application data in the secure data table (FIG. 6), and then would issue the one or more commands necessary to execute the desired action. Among the potential actions that may be used by applications 200 or wallet user interface 410 are those associated with:
a. wallet management (e.g., setting, resetting or enabling wallet passcodes; get URL of OTA server; over-the-air registry provisioning; setting payment timing; increasing payment timing; set default card; list issuers, list supported credentials; set display sequence of credentials; set credential storage priority; create categories/folders; associate credentials with categories; memory audit; determine Secure Element (SE) for storage of credential; get offers; update wallet status);
b. credential management (e.g., add credential; view credential detail; delete credential; activate credential (for redemption/payment); deactivate credential; search credentials; list credential capability; set default credential; lock/unlock credential; require passcode access; get credential image; set access passcode);
c. Secure Element (SE) Management (e.g., create security domains for issuers; rotate keys; load applications; update applications; wallet lock/unlock; SE lock/unlock); and
d. Personalization (e.g., add credential; delete credential; suspend/unsuspend credential; notification for issuer; metadata update; notification for card metadata update).

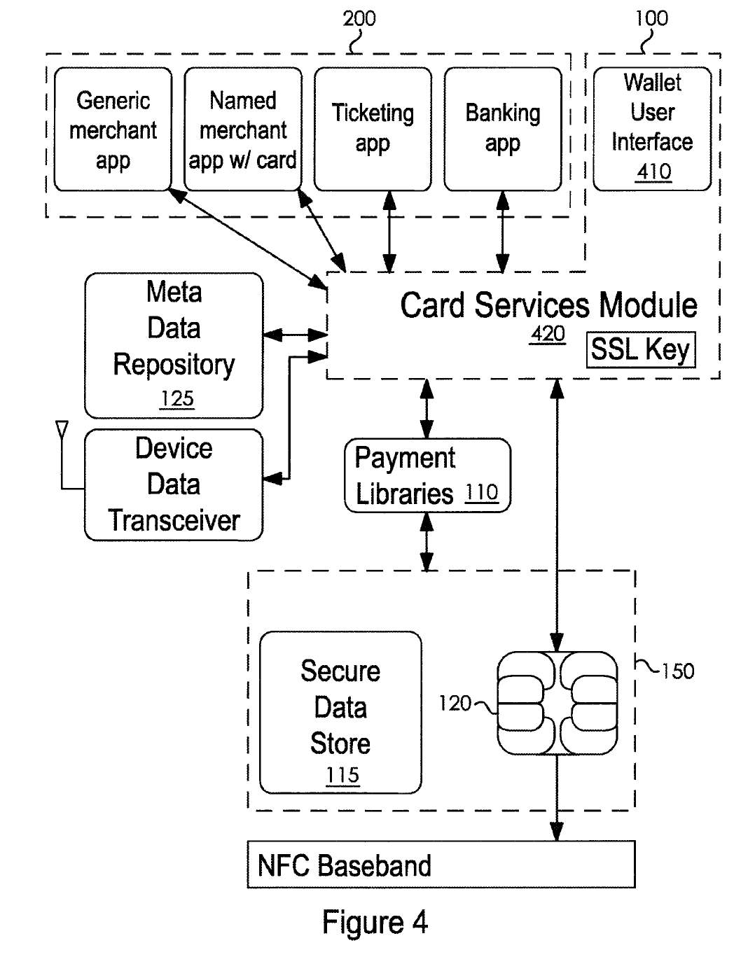

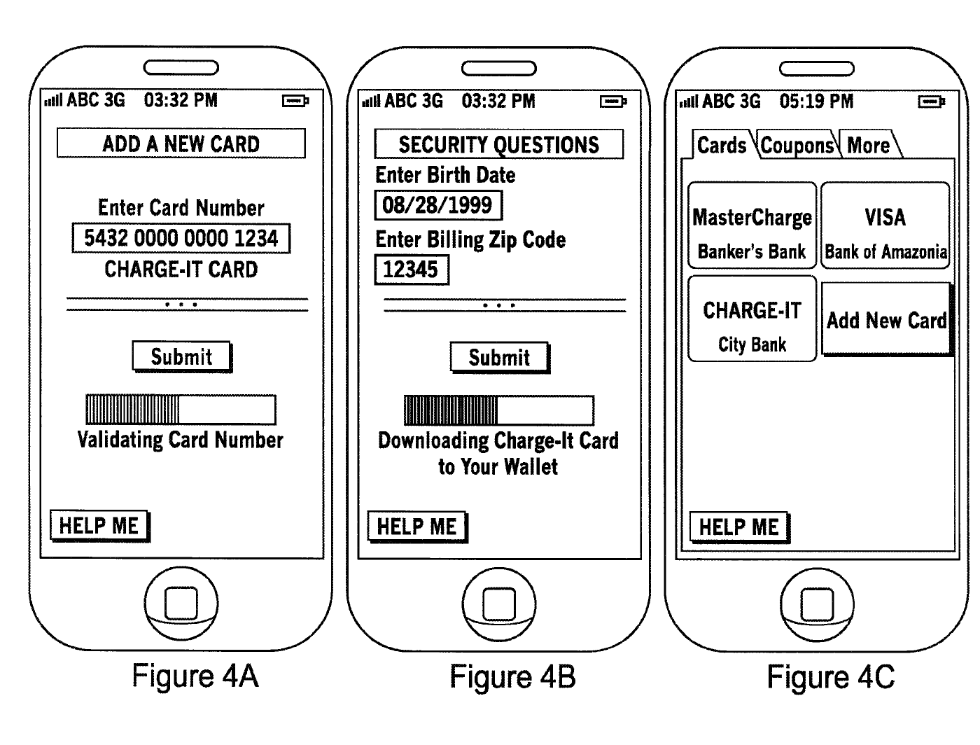

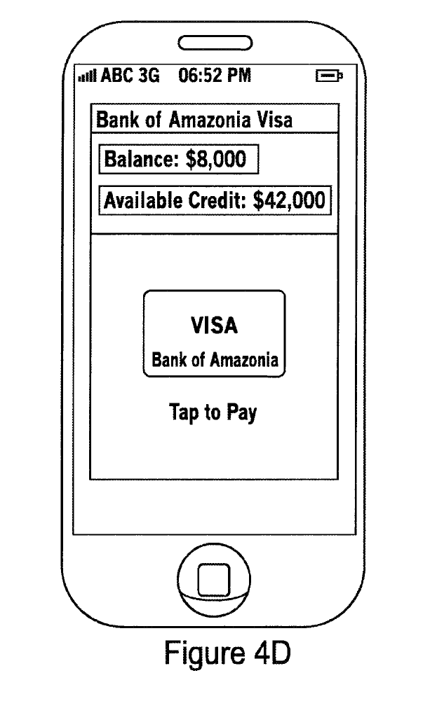

FIG. 4 illustrates further detail of the “OpenWallet” block of FIG. 2. As shown, the functions of “OpenWallet” 100 can be integrated into a single dedicated module that provides a user interface that is closely coupled to the card services. In another embodiment illustrated in FIG. 4, the capabilities and functionality of OpenWallet 100 may be distributed between a Wallet User Interface 410 and a Card Services Module 420. The distributed approach would allow applications to have direct access to the Card Services Module 420 without having to use the user interface provided by Wallet User Interface 410. The Card Services Module 420 may be configured to track the issuer of all card, coupon, access and ticket data stored in the payment subsystem 150 of the portable communication device 50 and determine on an application-by-application basis whether an application should have permissions to view, select, use and/or change secure data stored in the payment subsystem. The wallet user interface 410 provides a user interface through which a user may register, provision, access and/or use the information securely stored in association with the card services module 420 relating to the user's credentials. Because the wallet user interface 410 is separated from the card services module 420, the user may elect to use one of the third party applications 200 to manage information in the Card Services Module 420. As further shown in FIG. 4, metadata (such as credential logos (e.g., Amtrak®, MasterCard®, TicketMaster®, and Visa®) and affinity images (e.g., AA Advantage® and United Mileage Plus®)) may be stored in memory 125 for use by the third party apps 200 or wallet user interface 410 in rendering a more friendly user experience. As this metadata can be shared across applications, the storage needed to implement secured transaction may be minimized.

Various screen shots of one exemplary wallet user interface 410 that may be deployed on a smart phone are shown in FIGS. 4A, 4B, 4C and 4D. Among other things these figures illustrate the functionality of registering, provisioning, access and/or using information securely stored in association with the card services module 420. FIG. 4A depicts that the wallet can hold various credentials such as cards, coupons, tickets and more. FIG. 4A further depicts that multiple cards may be stored in the wallet 100. As shown in FIG. 4D, upon selecting the Visa® card from the screen illustrated in FIG. 4A, the wallet user interface opens another screen that provides an interface for the user to initiate a secure NFC payment transaction. As also depicted, the user interface may show balance and available credit information.

### Credential Provisioning

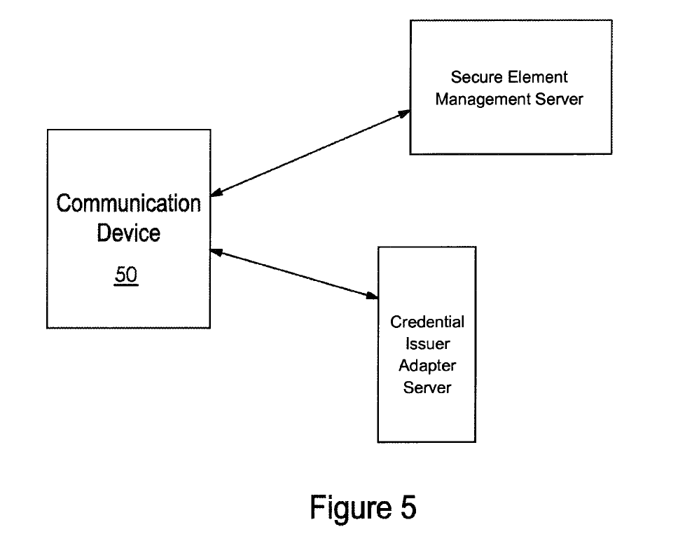

FIG. 5 illustrates one exemplary system architecture that may be utilized to provision credentials in the system. As shown, the user's portable communication device 50 is configured to communicate with a secure element management server and a credential issuer adapter server. The secure element management server (which may alternatively be known as a Card Application Management System) is configured to validate a user's credentials. For example, if the user wishes to store information relating to a credit card in the secure element 120 of device 50, they would input their credit card information via a user interface displayed on device 50.

The user interface may be generated by wallet user interface 410 or a trusted third party application 200 supported by OpenWallet 100. As an example, FIGS. 4A and 4B, illustrate the provisioning of a “Charge-It Card” into the wallet using one exemplary wallet user interface 410 that may be deployed on a smart phone. Underlying either user interface, the card services module 420 preferably transmits the first six digits of the identified credit card (commonly referred to as the Bank Identification Number or BIN) to the secure element management server, which then validates the card issuer's compliance rules and facilitates a direct key exchange between the OpenWallet 100 (or Card Services Module 420) on the user's mobile device 50 and an appropriate credential issuer adapter server in an encrypted fashion as was previously known in the art.

Various approaches to the direct key exchange may be facilitated by a variety of off-the-shelf solutions provided by entities including, but not limited to, Gemalto N.V. (Amsterdam, The Netherlands), Giesecke & Devrient (Munich, Germany), SK C&C (Korea) (Corefire), or VIVOtech Inc. of Santa Clara, Calif. (ViVoTech credential issuer adapter server). The credential issuer adapter server authenticates the user, executes issuer rules and then initiates the personalization process. The credential: issuer adapter server is preferably a server operated by the issuer of the credentials that the user is seeking to provision. The credential issuer adapter server may verify the user, for example by providing a series of verification questions based on user information previously provided to the issuer (see FIG. 4B). Once verified, the credential issuer adapter server passes the full 16 digit credit card number to the secure element 120 via the card services module 420. The credential issuer adapter server may also pass metadata, such as information relating to the look and design of the selected credit card to the application memory 125. On completion, the credential issuer adapter would notify the secure element management server about the completion of the transaction. As shown in FIG. 4C, following provisioning the wallet user interface 410 would include the Charge-It Card, which the user could select using user interface techniques that are well-known in the art of smart phone user interfaces.

### Validating Third Party Applications

As noted above, OpenWallet 100 verifies the trusted status of any third party application 200 before that application is allowed access to the secure element 120 (or secure data store 115 and even preferably the metadata repository 125) on the portable communication device 50 to view, select and/or change secure data stored in the payment subsystem 150. In one approach noted above, this verification may be accomplished by accessing a local authorization database of permitted or trusted applications. In a preferred approach, the local authorization database in cooperates with a remote authorization database associated with one or more servers associated with system management back end 300.

FIG. 6 is a block diagram of one potential implementation of one potential combination of local and remote authorization databases to enhance security of the card services module 420, secure element 120, and payment subsystem 150. As shown in FIG. 6, a User A/C Registry (or User Account Registry) may be associated with the server (or otherwise deployed in the cloud). The User A/C Registry may store the identification of the secure element 120 disposed in each user's portable device 50. Entries in the User Account Registry may be added for each user at any point in the process.

The “Issuer Registry” database is a database of approved Issuers. The Issuer ID is unique for each type of credential. In other words, if a bank has multiple types of credentials (e.g., debit cards, credit cards, affinity cards, etc.) each credential type would have its own Issuer ID (e.g., I-BofA-II). In a preferred approach, the Issuer ID as between multiple types of credentials would have some common elements, so as to indicated that the credentials are at least related (e.g., I-BofA-I). In this way applications from same issuer can share data with the other application of the same “extended” issuer. In a preferred approach, card services module 420 can be simplified by requiring even the wallet user interface 410 (which “ships with the system”) to have an Issuer ID (as well as an Application ID and Compile token).

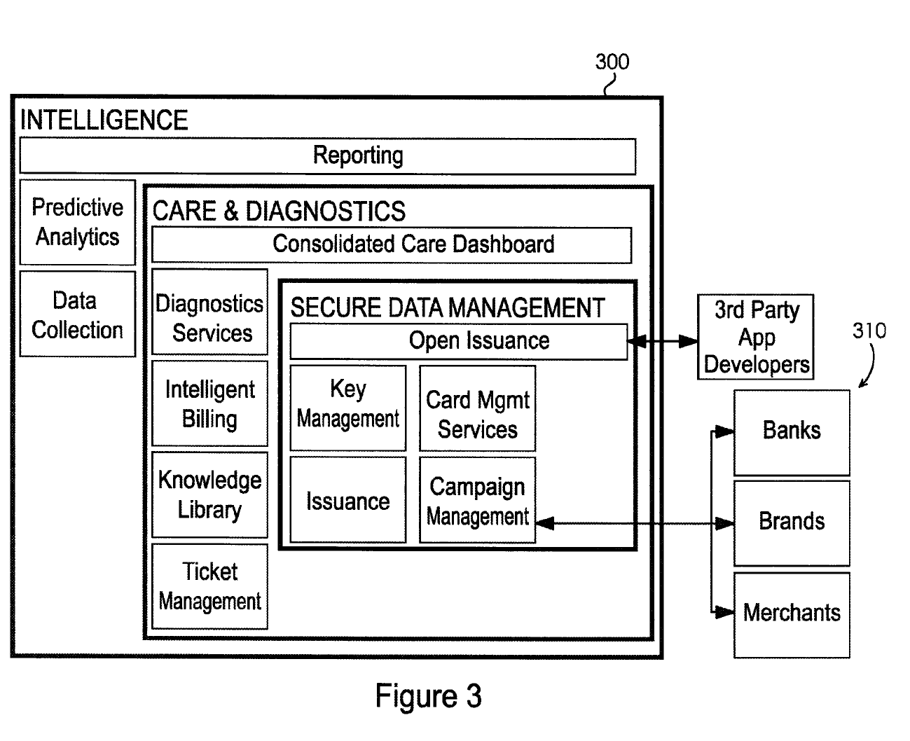

The “Application Registry” is a database of applications (mostly third party) that have pre-approved by an operating system provider. Like the User A/C Registry, the “Application Registry” and “Issuer Registry” database are maintained on the server side (or otherwise in the cloud) in operable association with OpenIssuance (see FIG. 3). As would be understood by those of ordinary skill in the art having the present specification before them, the various registries may be implemented in separate databases or one unified database. At initiation of a wallet 100 and preferably at substantially regular time-intervals thereafter (e.g., daily), the data stored in the Application Registry of Open Issuance (see, FIG. 3) is distributed to devices with the wallet to be stored locally.

As shown in FIG. 6, the Application Registry may include, among other information, an Application ID (“App ID”), an Issuer ID, and a Compile ID or token. The Compile ID is a global constant generated for each application by one or more processes associated with Open Issuance (FIG. 3) during the qualification process for the particular application 200. After it is generated by a particular card services module 420 on a unique device 50, the Compile token is included or otherwise associated with the application. This Compile token is preferably generated by a pseudo-random number generator local to the device that uses a pre-determined seed, such as the Application ID, Compile ID, Issuer ID or some combination thereof.

When the user seeks to qualify a third party application with the card services module 420 on a device 50, the Compile ID (a digital token) and Application ID (a digital identifier) associated with the third party application may be matched against the Compile ID and Application ID pairs stored in the Card Services Registry stored on the device 50 (see FIG. 6). As should be understood by those skilled in the art having the present specification before them, the same Compile and Application ID pairs are transmitted to (or in some instances pre-stored within) other devices 50 associated with the system, as well. If the Compile ID/Application ID pair matches one of the pair-stored in the Card Services Registry on the device, a Secret Token ID is preferably generated on the device 50 by a pseudo-random number generator (such as the one associated with the Secure Element 120 and then stored in association with the Compile ID/Application ID pair in the Card Services Registry on the device 50. In some instances, the Compile ID may be pre-selected and used to seed the random number generator. It should be understood that one or more pieces of other predetermined data associated with the card services registry could be preselected as the seed instead. The Card Services Registry is preferably stored in secure memory (rather than the secure element 120 because secure element 120 has limited real estate) and the Card Services Registry is preferably further encrypted using standard encryption techniques. The Secret Token ID is also embedded in or otherwise associated with the application 200 on the device 50 in place of the Compile ID that was distributed with the application.

After the third party application has been loaded into the Card Services Registry (and the secret token embedded in the application), the third party application may launch and may prompt the user to opt-in to provide access to the issuer-specific credential(s) needed for (or otherwise desired for use with) the now validated (or trusted) application. In each subsequent launch of the third party trusted application, the embedded Secret Token and/or Application ID are compared to the data in the Card Services Registry on the device. If there is match, the application is trusted and can access the payment subsystem 150 via card services module 420. In this manner, it can be seen that the Secret Token and/or Application ID associated with any of applications 200 or wallet user interface 410 may also be removed from the Card Services Registry and thus would be disabled from accessing the payment subsystem and possibly the application, altogether. Similarly, if any application 200 or wallet user interface 410 are tampered with the Secret Token and/or Application ID will be invalidated. The Issuer Registry, Card Services Registry, Application Registry, User NC Registry, and the permissions table, such as the one described below, may be protected by encrypting the table using, for example, a security algorithm (e.g., advance encryption standard (AES) algorithm, the secure hash algorithm (SHA), message digest 5 (MD5) algorithm, and the like) with a key value that is a hash generated from one or more parameters (e.g., a secure element ID, passcode, etc.) as inputs. If a rogue application tampers with the Card Services Registry, for instance, the card services module 420 would detect the change, lock the wallet and invoke remote procedures to replace the permission table with one retrieved from the secure element management server.

Card services module 420 also preferably uses the trusted application verification step to determine the appropriate level of subsystem access allowed for each application 200. For example, in one embodiment, one application 200a may be authorized to access and display all of the data contained in the payment subsystem 150, where another third party application 200x may be only authorized to access and display a subset of the data contained in the payment subsystem 150. In yet another embodiment, an application may be permitted only to send a payment or transaction requests to OpenWallet 100, but may not itself be permitted to access any of the data contained in the payment subsystem 150. In one approach, assignment of permissions to the application can be thought of as follows:

| | | All | Extended | Own |
|---|---|---|---|---|
| | Reserved | Credentials | Issuer | Credentials |
| Read | 0 | 0 or 1 | 0 or 1 | 0 or 1 |
| Write | 0 | 0 or 1 | 0 or 1 | 0 or 1 |
| Delete | 0 | 0 or 1 | 0 or 1 | 0 or 1 |
| Activate/Deactivate | 0 | 0 or 1 | 0 or 1 | 0 or 1 |
| Download | 0 | 0 or 1 | 0 or 1 | 0 or 1 |
| Credential | | | | |

These permissions can be used to form 4 hexadecimal number in the order shown above from most to least significant figure. As shown in the example Card Services Registry of FIG. 6, the I-BofA-II issuer has permission level 11111, which can be thought to expand to 0001 0001 0001 0001 0001. In other words, the I-BofA-II application can read, write, delete, activate/deactivate, and download its own credentials but not the extended issuer credentials let alone all credentials. If BofA had another issuer code (e.g., I-BofA-1), then that would be an extended Issuer application. So, if the permission level of the application associated with Issuer ID “I-BofA-II” was set to 0010 0001 0001 0010 0001 (or 21121 hexadecimal) then the application would be able to read and activate/deactivate the credentials associated with both issuer IDs. In yet another example, the wallet user interface 410 may be given a permission level of 44444 (i.e., 0100 0100 0100 0100 0100). In other words, the wallet user interface 410 can read, write, delete, activate/deactivate, and download all credentials. As would be understood by those of ordinary skill in the art, these are merely examples of potential permissions that can be granted to applications, other permissions are contemplated. For instance, some applications may have the ability to read extended issuer credentials, but only write, delete, activate and download the application's own credentials (e.g., 21111, which expands to 0010 0001 0001 0001 0001). In yet another example, an application may only be given activate/deactivate and download tights (e.g., 0000 0000 0000 0001 0001 or 00011 in hexadecimal). In yet another example, an application may be disabled—without being deleted from the trusted application database or Card Service Registry—by setting all rights to zero.

### Token Generation and User Password Verification

Password security is becoming increasingly important. A challenge exists to maintain security of the password, while simultaneously keeping the password simple enough for a user to remember. Storing a password, in whole or in part, on a portable communication device 50, however, practically always presents a risk that the password may be stolen. No matter what security measures are put in place, hackers will attempt to surreptitiously obtain the password from device 50.

The example embodiments overcome these issues by not storing a user's password anywhere on the portable communication device 50. Instead, only the user knows the password and enters the password when the user desires to access and/or use a credential. While the device 50 does not know the password, the device 50 is still capable to verifying the entered password based on whether device 50 generates a correct key using the entered password. Device 50 may use the generated key to decrypt one or more tokens stored by device 50 and the device 50 may check whether the token was properly decrypted. If properly decrypted, the device 50 may determine that the user entered the correct password and may then use the key to decrypt an encrypted credential stored by the device 50 for use in an NFC transaction. If the key is not correct, device 50 cannot properly decrypt the token and hence will be unable to decrypt any encrypted credentials. Thus, the example embodiments do not store the user's password anywhere on device 50, yet the device 50 can determine whether the user entered the correct password based on whether a key generated from the password is capable of decoding a stored token. As described in further detail below, the example embodiments may perform a token generation process to generate and store a token on the device 50, and may perform a password verification process to verify that an entered password produces a key that is able to properly decrypt the token.

In an example, the portable communication device 50 may proceed through a registration process where a token and the user's password are established. Registration may occur at the factory or when a user downloads the CSM 420 to device 50. In an example, trust may be established between device 50 and system management back end 300 during a registration process conducted in accordance with techniques described in co-pending U.S. patent application Ser. No. 13/916,307, filed Jun. 12, 2013, and titled “System and Method for Initially Establishing and Periodically Confirming Trust in a Software Application,” the content of which is entirely incorporated herein by reference.

As part of registration, the user may establish a password. The password may be a set of alphanumeric or hexadecimal characters (e.g., one or more letters, numbers, or symbols, and any combination thereof), a personal identification number (PIN), a biometric identifier (e.g., a user's fingerprint), other information for uniquely identifying the user, and any combination of the foregoing. The user may also establish a site key. A site key may be an image (e.g., picture of a flower) or phrase that the user selects for identification purposes. A site key is a commonly used mechanism to enable an end user to trust that a service he/she is using is authentic. In some examples, a site key may be used to establish trust between a user and a back end server. Once the password and site key are established, the device 50 never stores either and instead both are stored only by the system management back end 300.

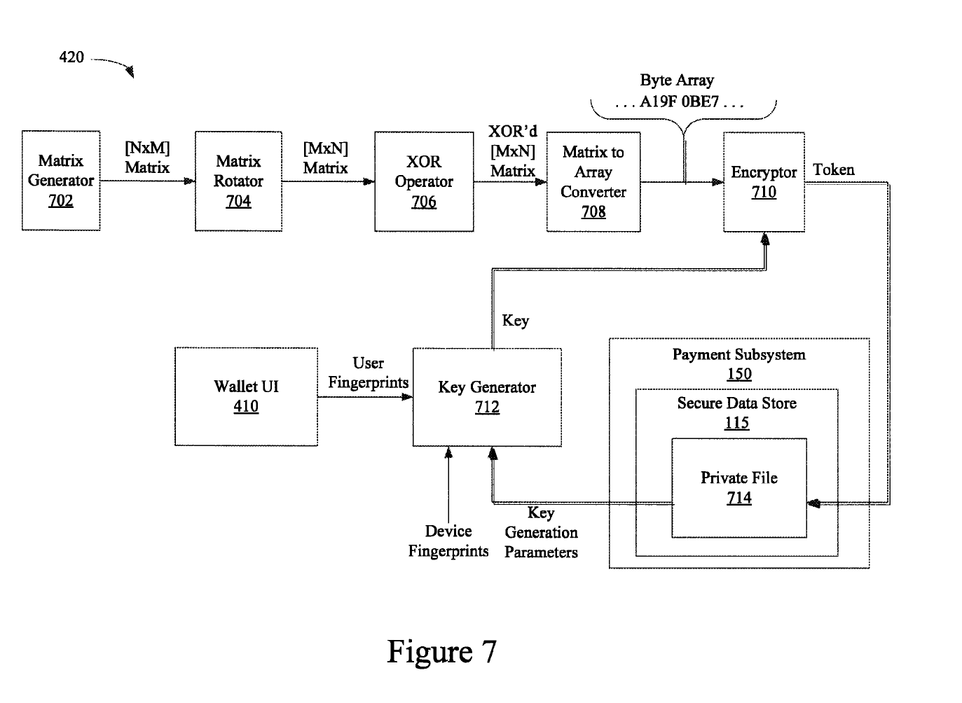

The CSM 420 may use the password and site key to generate the token. The token is stored on the device and used to verify that the user has entered the correct password. In an example, the token may be a byte array, a string, a JavaScript Object Notation (JSON) object, and the like. The byte array may be a sequence of hexadecimal, decimal, or binary digits, or other sequence of digits in another numeral system. FIG. 7 illustrates an example functional block diagram implementing a process for generating a token in accordance with example embodiments. As depicted, the CSM 420 may include a number of functional blocks that operate in conjunction with the wallet user interface 410 and the payment subsystem 150 for generating and storing a token. In an example, the CSM 420 may include a matrix generator 702, a matrix rotator 704, an “exclusive or” (XOR) operator 706, a Matrix to Array converter 708, an encryptor 710, and a key generator 712. A single or multiple processors may implement functional blocks 702-712, as well as the other functional blocks described herein. For example, each functional block may represent software code executed by one or more processors. In another example, each functional block may be a hardware component. In other examples, each functional block may be a combination of hardware and software.

The matrix generator 702 may generate an N×M matrix (i.e., N rows by M columns) of bytes (e.g., hex bytes). N and M are non-zero, positive integers and may even be equal. In an example, the matrix generator 702 may generate the N×M matrix as a byte array (e.g., a hexadecimal byte array). In another example, the CSM 420 may receive the byte array from the system management back end 300 during registration.

The generated token may be self-validateable by a cyclic redundancy check (CRC), a LUHN check, or any other self-validation technique (e.g., short cryptograms). The token may not be easily replaced or modified unless one knows a pattern (e.g., used for validating and/or creating the token). In an example, the matrix generator 702 may include a block generator that uses a random number generator to generate the token as a hex byte array. The block generator may confirm that the generated token may pass CRC rules for self-verification (or other self-verification rules). The block generator may also calculate and add missing numbers to a byte array to make the token valid under the self-verification rules. Any other token bytes can be streamlined and filled by the random number generator.

A matrix rotator 704 may receive and rotate the N×M matrix to output a M×N matrix. In a simple example, the matrix rotator 704 may rotate the matrix clockwise (or counterclockwise) by 90 degrees. The XOR operator 706 may perform an XOR operation on the M×N matrix (e.g., exclusive or (XOR)) to output an XOR′d M×N matrix, with some or all input bytes being XOR′d (e.g., XOR every input byte). For example, the XOR operator 706 may perform a logical “exclusive or” on selected combinations of elements within the matrix. The Matrix to Array converter 708 may convert the XOR′d M×N matrix to a byte array that is input to an encryptor 710.

Another input to the encryptor 710 is a key generated based on a password input by the user. In an example, the Wallet UI 410 may prompt the user to enter the password established during registration. The key generator 712 may use the password to generate a key. In an example, the key generator 712 may generate the key as a function of device fingerprints and key generation parameters including one or more of user fingerprints, a slider, and other parameters described below. In some examples, the key may be a symmetric key. Other types of keys may also be generated.

A device fingerprint may be data or a set of data unique to device 50 (e.g., Mobile Station International Subscriber Directory Number (MSISDN), Integrated Circuit Card Identifier (ICCID), ESN, IMSI, etc.). The key generator 712 may retrieve this information via an application programming interface (e.g., Android System API). By using device-specific information, the key generator 712 may uniquely associate the generated key with that specific device 50, such that the generated key cannot be successfully used by other devices.

The slider may be a substring derived from a site key selected during wallet registration. For example, the key generator 712 may apply a windowing function to select a predetermined portion of the site key (e.g., having an original index offset and window length). The key generator 712 may receive the windowing function from the system management backend 300. The slider may make the key generation process dynamic and may help to avert reverse engineering attacks. Using a slider in combination with the iteration counter overcomes weaknesses of the iteration counter (e.g., ‘linear’ sequence and ‘max’ value). The slider overcomes these troubles and diverts an attacker ‘guess’ work (e.g., increasing/decreasing sequence).

A user fingerprint may be data or a set of data unique to a user. In some examples, the user fingerprint may actually be a physical fingerprint of a user's finger or other biometric information detected from a user. In other example, a user fingerprint may not include any biometric information. An alphanumeric password is an example of such a user fingerprint. The user may be required to enter his/her password before payment (or while selecting a payment card). The user fingerprint might not be stored on device 50 in any way (e.g., via encryption, salting, obfuscation, etc.), thus preventing hacking the device 50 or otherwise ‘computing’ the user's password.

The key generator 712 may apply a key derivation algorithm that uses as input one or more user fingerprints (e.g. a password, a site key, and/or user demographic information), one or more device fingerprints, and one or more key generation parameters. An example of the key derivation algorithm is PBKDF2WithHmacSHA1 used by Android devices. Other key derivation algorithms may also be used. So, the key generation function for a symmetric key can be generalized to: SymmKey=function (user_fprints, dev_fprints, key generation parameters).

Key generation parameters may include an initialization vector, a salt, a slider, and/or an iteration count. The initialization vector may be a fixed size amount of data input into the key derivation algorithm. For example, a random number generator of device 50 or system management back end 300 may produce the initialization vector. The fixed sized data may be a value that is random or pseudorandom. A salt may be random data input to the key derivation algorithm to make a dictionary attack more difficult. In some examples, the key generator 712 may use a sprinkler plus “exclusive or” (XOR) technique to generate the salt. In an example, a sprinkler may be a block generator that shuffles a given input accompanied by one or more byte injections. While the salt may be used with the password to derive the key, unlike the password, the salt might not need to be kept secret. For example, the salt may be encrypted when stored on the device 50 or may be stored unencrypted. The length of the salt may be based on the length of the key. In one example, the salt length is ⅛^{th} the length of the expected symmetric key (i.e., 256 bits to 8 bits).

An iteration count may identify the number of times to run the key derivation algorithm to generate the key. Performing the key derivation algorithm multiple times has little effect on legitimate use, where only one try is needed to derive the key from the correct password, but performing it multiple times considerably slows down brute force attacks which try out multiple passwords in a row. For example, a large iteration count may make key derivation computationally expensive for hackers (a security technique that may be referred to as key stretching).

For comparison, if a salt and iteration count are not used, it may be easier to use pre-generated keys based on a list of common passwords for a brute force attack. By using a random ‘salt’ (so called because it is used to ‘season’ the password), multiple keys can be constructed based on the same password, and thus an attacker needs to generate a new key table for each salt value, making pre-computed table attacks much harder.

The encryptor 710 may encrypt the data array using the key output by key generator 712 to generate a token. For example, the encryptor 710 may apply the advanced encryption standard to encrypt the data array. Other encryption techniques may also be used. The encryptor 710 may output the token to the payment subsystem 150 for storage in a private file 714.

The private file 714 is may be a file generated by an application and only that application can access and/or open it for reading. The private file 714 may also store one or more of the user's credentials and some or all of the key generation parameters. In an example, the credential data may have two parts: sensitive data and cleartext data. The encryptor 720 may encrypt the sensitive data with the key prior to storage in the private file 714, and it is optional whether the cleartext data is encrypted. In an example, the sensitive data may be encoded first, added to output binary byte array, and then the whole binary object (e.g., hex byte array) may be stored on device 50. The key may also be used to decrypt the sensitive data, but decryption may not occur until shortly before a particular credential (e.g., payment card) is to be used during an NFC transaction.

In some examples, the CSM 420 may periodically update the key and re-encrypt credential data stored in private file 714. For example, a key may have a predetermined time to live. Once expired, the CSM 420 may generate a new key by using input parameters described above.

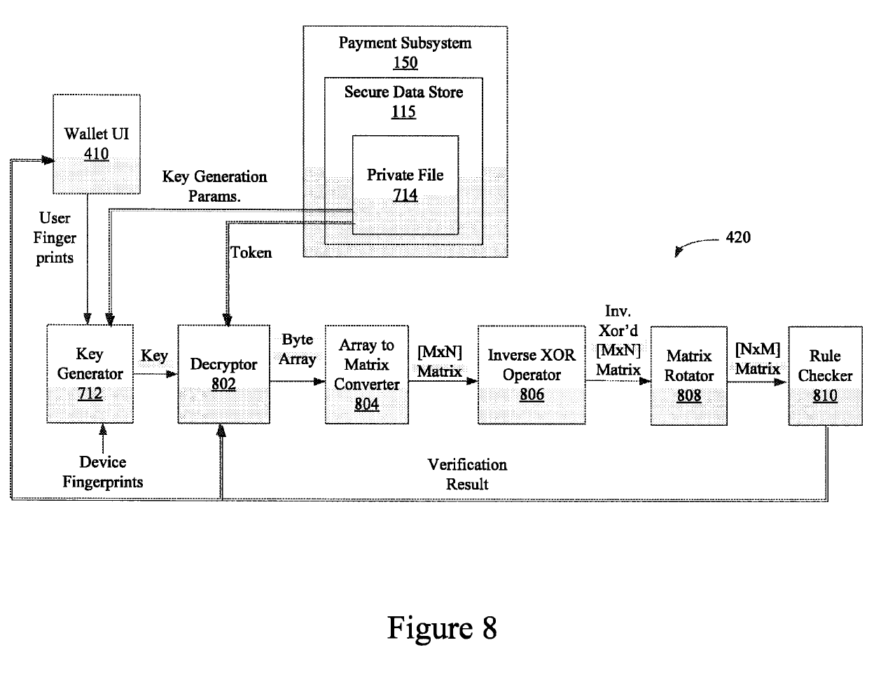

The CSM 420 may use the token to verify that a user has input the correct password when attempting to perform an NFC transaction. FIG. 8 illustrates an example functional block diagram implementing a process for verifying a user password in accordance with example embodiments. A user may launch the wallet UI 410 when attempting to complete an NFC transaction (e.g., make a payment using a payment credential, use a coupon credential, open a door using an access credential, etc.). The wallet UI 410 may prompt the user to input his/her password and/or to select his/her site key, and the UI 410 may forward the user fingerprints (e.g., password and/or site key) to the CSM 420.

The key generator 712 of the CSM 420 may use user fingerprints to generate a test key. If the user has input the correct password, the CSM 420 will be able to properly decrypt the token stored in the private file 714 using the test key and thus verify that the user input the correct password. If the user inputs an incorrect password, the CSM 420 will be unable to properly decrypt the token using the test key and thus indicate the user did not input the correct password.

In an example, the key generator 712 may generate the test key in the same manner as described above with reference to FIG. 7 and may output the test key to the decryptor 802. The decryptor 802 may retrieve the token and decrypt the token using the test key to generate a byte array (e.g., a hexadecimal byte array). The Array to Matrix converter 804 may convert the byte array to an M×N matrix. The inverse XOR operator 806 may perform an XOR operation on the M×N matrix that is inverse to the XOR operation performed by the XOR operator 706. The Matrix rotator 808 may rotate the M×N matrix output by the inverse XOR operator 806 to generate an N×M matrix.

A rule checker 810 may verify that the N×M matrix passes verification rules to confirm that the token was properly decoded using the test key. Example verification rules may be based on (1) eigenvalues and eigenvectors for the N×M matrix having predetermined values and/or vectors, (2) a cyclic redundancy check associated with a prime number unique to each application for some or all columns, rows, and/or diagonals has an expected value, (3) an expected cryptogram, and the like. If the N×M matrix fails the verification rules, the rule checker 810 may inform the wallet UI 410 of the failure and prompt the user to re-enter his/her password and/or reselect his/her site key until a predetermined number of failures have occurred (e.g., no more than 3 failures). If the predetermined number has been reached, the wallet UI 410 may prevent any further password entry attempts to prevent, for example, a brute force attack by locking the wallet application or even erasing all wallet credentials.

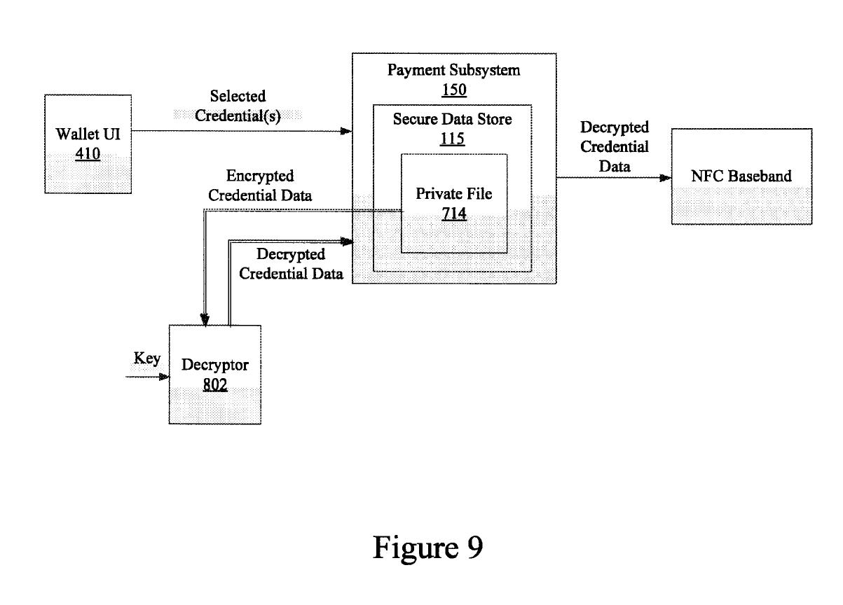

If the N×M matrix passes the verification rules, the rule checker 810 may inform the wallet UI 410 that the password has been verified. The wallet UI 410 may then prompt the user about what type of operation he/she would like to perform. For example, the wallet UI 410 may present a GUI prompting a user to select a requested transaction (e.g., to make a payment, to use a coupon, to open a door, and the like). With reference to FIG. 9, the wallet UI 410 may inform the payment subsystem 150 which credential(s) the user has selected. In some wallet applications (e.g., public transportation, hotel doors, etc.), password verification might be needed only once—e.g., after phone reboot.

Based on the selected transaction, the payment subsystem 150 may retrieve the corresponding credential from the private file 714 and forward the encrypted credential data to the decryptor 802 for decryption. For example, the user may select one or more credit cards to use when making a payment. The decryptor 802 may decrypt credential data for each of the selected credit cards using the test key and return decrypted credential data to the payment subsystem 150. The payment subsystem 150 may forward the decrypted credential(s) to a POS terminal via the NFC baseband attempting to complete the transaction requested by the user. Communication of multiple credentials may be in accordance with assignee's U.S. Pat. No. 8,811,895, issued Aug. 19, 2014, titled “System and Method for Presentation of Multiple NFC credentials during a Single NFC Transaction,” the contents of which are entirely incorporated herein by reference. Any credentials not selected by the user may remain encrypted and stored within the private file 714 (e.g., data for a particular one of the credit cards not selected to make a purchase).

The example embodiments provide a number of advantages. One such advantage is that device 50 does not store a password. Storing a token on device 50 instead of a password is advantageous because it is not presently possible to derive/re-engineer the password or key from a token using the encryption and key derivation algorithms used herein. In other words, the token itself has no value to a hacker. Even if a hacker can replace a token stored by device 50 with a trojan token, the password verification process described herein would fail because it would be unable to properly decrypt the trojan token. Thus, in all embodiments, device 50 advantageously does not store a password, but may verify that the user has entered the appropriate password prior to making an NFC transaction or giving an access to wallet credentials.

The foregoing description and drawings merely explain and illustrate the invention and the invention is not limited thereto. While the specification is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the rut will be able to devise various arrangements which, although not explicitly described or shown herein, embody the principles of the invention and, thus, within its scope and spirit.

1. A method associated with a device having near-field communication capabilities, the method comprising:
receiving, by the device, a password input by a user, wherein the password is not stored on the device prior to receiving the password;
generating an encryption key as a function of the user-input password;
decrypting an encrypted token using the encryption key;
verifying whether the token was properly decrypted;
in response to verification that the token was properly decrypted, decrypting a credential using the encryption key; and
initiating a near-field communication transaction with a reader using the decrypted credential.

2. The method of claim 1 wherein generating the encryption key is additionally a function of one or more device-specific values.

3. The method of claim 2 wherein generating the encryption key is additionally a function of one or more key generation parameters selected from the group comprising: user biometric data, a slider value, an iteration counter value, an initialization vector, and a salt.

4. The method of claim 3 further comprising encrypting a token using the encryption key to form the encrypted token.

5. The method of claim 4 further comprising creating the token by
rotating a N×M matrix of data bytes, where N and M are non-zero positive integers;
applying exclusive or to every byte in the rotated N×M matrix; and
converting the rotated the XOR′d N×M matrix into an array.

6. The method of claim 5 further comprising validating the N×M matrix of data bytes using one or more self-validation techniques selected from the group comprising a cyclic redundancy check, a LUHN check, and short cryptogram.

7. The method of claim 6 further comprising storing the encrypted token in an encrypted manner.

8. The method of claim 1 wherein generating the encryption key is additionally a function of one or more key generation parameters selected from the group comprising: user biometric data, a slider value, an iteration counter value, an initialization vector, and a salt.

9. The method of claim 9 wherein the slider value is generated by applying a windowing function at a predetermined position of a site key.

10. A system comprising:
at least one processor; and
at least one memory storing computer readable instructions that, when executed by the at least one processor, cause the system to:
receive a password input by a user, wherein the password is not stored on the system prior to receiving the password;
generate an encryption key based on the password;
decrypt a token using the encryption key;
in response to verifying that the token was properly decrypted, decrypt a credential using the encryption key; and
initiate a near-field communication transaction with a reader using the decrypted credential.

11. The system of claim 10 wherein the least one memory storing computer readable instructions that, when executed by the at least one processor, further causes the system to generate the encryption key additionally based on one or more device-specific values.

12. The system of claim 11 wherein the least one memory storing computer readable instructions that, when executed by the at least one processor, further causes the system to generate the encryption key additionally based on one or more key generation parameters selected from the group comprising: user biometric data, a slider value, an iteration counter value, an initialization vector, and a salt.

13. The system of claim 12 wherein the least one memory storing computer readable instructions that, when executed by the at least one processor, further causes the system to create a token by
rotating a N×M matrix of data bytes, where N and M are non-zero positive integers;
applying exclusive or to every byte in the rotated N×M matrix; and
converting the rotated the XOR′d N×M matrix into an array.

14. The system of claim 13 wherein the least one memory storing computer readable instructions that, when executed by the at least one processor, further causes the system to validating the N×M matrix of data bytes using one or more self-validation techniques selected from the group comprising a cyclic redundancy check, a LUHN check, and short cryptogram.

15. The system of claim 15 wherein the least one memory storing computer readable instructions that, when executed by the at least one processor, further causes the system to store the encrypted token in an encrypted manner.
